(19) United States
(12) Patent Application Publication
(10) Pub. No.: US 2025/0227366 A1
(43) Pub. Date: Jul. 10, 2025

(54) METHOD FOR RECORDING A VIDEO, MOBILE TERMINAL, AND NON-TRANSISTORY COMPUTER-READABLE STORAGE MEDIUM

(71) Applicant: GUANGDONG OPPO MOBILE TELECOMMUNICATIONS CORP., LTD., Dongguan, Guangdong (CN)

(72) Inventor: Yunlong HU, Shenzhen, Guangdong (CN)

(73) Assignee: GUANGDONG OPPO MOBILE TELECOMMUNICATIONS CORP., LTD., Dongguan, Guangdong (CN)

(21) Appl. No.: 18/876,635

(22) PCT Filed: Feb. 11, 2022
(86) PCT No.: PCT/CN2022/076058

§ 371 Date: Dec. 18, 2024

(30) Foreign Application Priority Data
Mar. 23, 2021 (CN) 202110309713.6

(51) Int. Cl. H04N 23/667; G06F 3/04847; H04N 23/63

(52) U.S. Cl. CPC H04N 23/667; G06F 3/04847; H04N 23/631

(57) ABSTRACT

A method for recording a video, including: controlling a mobile terminal to enter a video recording mode and start recording a video, in response to an operating instruction to a camera button, in a case where the mobile terminal is in a photographing mode; controlling a video recording interface to display a movable icon and receiving a moving operation instruction to the movable icon; and adjusting one or more video recording parameters based on the move operation instruction to the movable icon.

### CROSS REFERENCE TO RELATED APPLICATIONS

This application is a 35 U.S.C. § 371 National Phase conversion of International Patent Application No. PCT/CN2022/076058, filed on Feb. 11, 2022, which claims priority to China Patent Applicant No. 202110309713.6, filed on Mar. 23, 2021, the entire contents of which are incorporated herein by reference.

### TECHNICAL FIELD

Embodiments of the present disclosure relate to the field of mobile terminal technologies, in particular, to a method for recording a video, a mobile terminal, and a non-transitory computer-readable storage medium.

### BACKGROUND

In existing mobile terminals, such as mobile phones, tablets, and etc., in order to use a system camera application to record a video, a user typically needs to first open the camera application, enter a photographing mode by default, then swipe a display screen interface to switch from the current photographing mode to a video mode, and finally press a camera button and start recording. Obviously, a method for recording a video in the existing camera application involves multiple operations and takes a relatively long time, making it difficult for the user to capture a fleeting moment when encountering a compelling scene during shooting.

### SUMMARY

Some embodiments of the present disclosure provide a method for recording a video, a mobile terminal, and a non-transitory computer-readable storage medium.

Some embodiments of the present disclosure provide a method for recording a video. The method may include the following:
controlling a mobile terminal to enter a video recording mode and start recording a video, in response to an operation instruction to a camera button, in a case where the mobile terminal is in a photographing mode;
controlling a video recording interface to display a movable icon and receiving a move operation instruction to the movable icon; and
adjusting one or more video recording parameters based on the move operation instruction to the movable icon.

Some embodiments of the present disclosure further provide a mobile terminal. The mobile terminal may include a camera device, a processor, and a memory. The camera device is configured to take a photo or record a video. The memory may store a computer program which, when executed by the processor, causes the processor to perform the aforementioned method for recording a video.

Some embodiments of the present disclosure further provide a non-transitory computer-readable storage medium. The non-transitory computer-readable storage medium may store a computer program which, when executed by a processor, causes the processor to perform the aforementioned method for recording a video.

### BRIEF DESCRIPTION OF THE DRAWINGS

To further illustrate the technical solutions in some embodiments of the present disclosure, a brief introduction to the figures used in some embodiments of the present disclosure is provided below. It should be understood that the figures described below are only for some of the embodiments of the present disclosure, which may not be considered as limiting the scope of the present disclosure. For those skilled in the art, other figures may be derived based on the following figures without creative work.

FIG. 1 is a structural block diagram of a mobile terminal.

FIG. 2 is a flowchart of a method for recording a video in some embodiments of the present disclosure.

FIG. 3 is a schematic view illustrating that a mobile terminal switches from a photographing mode to a video recording mode in some embodiments of the present disclosure.

FIG. 4 is a schematic view illustrating that a video recording interface includes a recording locked icon in some embodiments of the present disclosure.

FIG. 5 is a schematic view illustrating a division of one or more function setting regions in a video recording interface in some embodiments of the present disclosure.

FIG. 6 is a schematic view illustrating that a movable icon is controlled to reduce an optical zoom in some embodiments of the present disclosure.

FIG. 7 is a schematic view illustrating that a movable icon is controlled to increase an optical zoom in some embodiments of the present disclosure.

FIG. 8 is a structural block diagram of an apparatus for quickly recording a video in some embodiments of the present disclosure.

In the figures:
100, mobile phone; 110, radio-frequency (RF) circuit; 120, memory; 130, input unit; 140, display unit; 150, camera unit; 160, audio circuit; 170, wireless fidelity (WiFi) module; 180, processor; 190, power supply; 200, apparatus for quickly recording a video; 210, recording-mode entering module; 220, movable-icon control module; 230, parameter adjustment module.

### DETAILED DESCRIPTION

The technical solutions in some embodiments of the present disclosure will be clearly and comprehensively described below in conjunction with the figures in some embodiments of the present disclosure. Obviously, the described embodiments are merely some embodiments of the present disclosure, rather than all embodiments of the present disclosure.

The components in the embodiments of the present disclosure described and illustrated in the figures may be arranged and designed in various configurations. Therefore, the detailed descriptions of the embodiments provided in the figures are not intended to limit the scope of the present disclosure but merely represent some selected embodiments of the present disclosure. Based on the embodiments of the present disclosure, any other embodiment obtained by those skilled in the art without creative efforts falls within the scope of the present disclosure.

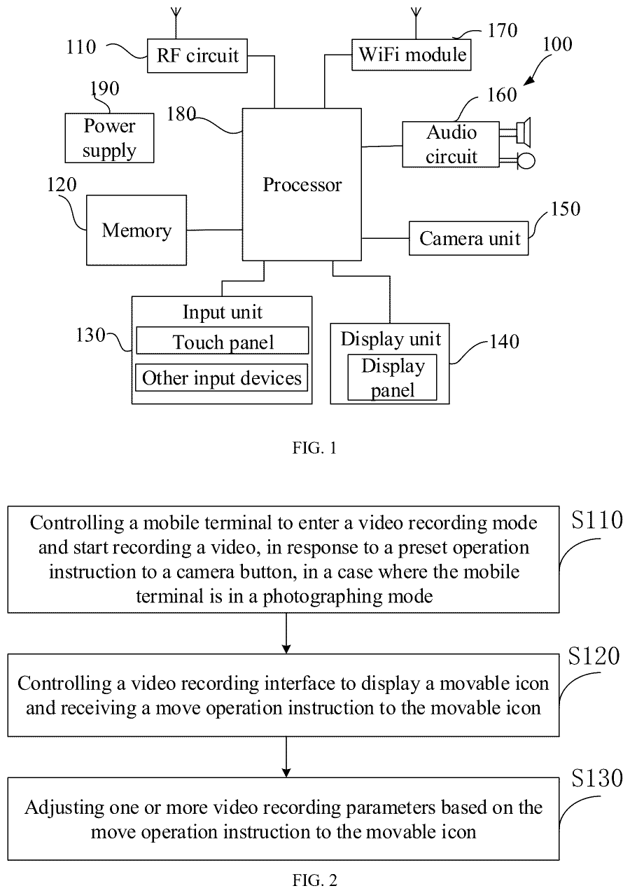

The following embodiments may be applied to a mobile terminal shown in FIG. 1, e.g., a mobile phone. FIG. 1 is a structural block diagram of the mobile phone. The mobile phone 100 may include a radio frequency (RF) circuit 110, a memory 120, an input unit 130, a display unit 140, a camera unit 150, an audio circuit 160, a wireless fidelity (WiFi) module 170, a processor 180, a power supply 190, and other components. The RF circuit 110 may be configured to receive and transmit wireless signal, etc. The memory 120 may be configured to store an application, user-related file information, and etc., that are necessary to operate the mobile phone 100. The input unit 130 may include a key, a touch panel, or other input devices to receive information and etc. that are input by a user. The display unit 140 may include a display panel and is configured to display an image, a text, and other information. The camera unit 150 may include a front camera, a rear camera, and etc., and is configured to take a photo, record a video, and etc. The audio circuit 160 is connected to an audio output device, such as an earpiece, a speaker, etc., and an audio input device, such as a microphone, etc. The audio circuit 160 is configured to record or play an audio, and etc. The WiFi module 170 is configured to transmit and receive a WiFi signal to implement an information transmission and etc. The processor 180, as a control center of the mobile phone 100, is configured to enable or control other units or modules to execute corresponding functions and etc. The power supply 190 includes a battery device and is configured to provide a required operating voltage for the modules or units of the mobile phone 100.

Those skilled in the art may understand that a structure of the mobile phone 100 shown in FIG. 1 may not limit the mobile phone. The mobile phone may include more or fewer components than those illustrated, or certain components show in FIG. 1 may be combined or arranged differently. In the following, the mobile terminal is used as an example to describe the technical solutions of the present disclosure. The mobile terminal is not limited to the mobile phone and may further include a tablet and etc. The following describes some embodiments of the present disclosure, but apparently the present disclosure is not limited to these embodiments.

### Embodiment 1

As shown in FIG. 2, some embodiments of the present disclosure provide a method for recording a video. The method may be applied to or performed by a mobile terminal, such as a mobile phone, a tablet, and etc. The method may enable the mobile terminal to swiftly switch from a photographing mode to a video recording mode, in order to meet user demands for capturing a dynamic moment in a timely manner, conveniently adjusting a recorded image, and etc.

As shown in FIG. 2, the method for recording a video is described in detail below.

In an operation S110, a mobile terminal may be enabled or controlled to enter a video recording mode and start recording a video, in response to a preset operation instruction to a camera button, in a case where the mobile terminal is in a photographing mode.

In some embodiments, the photographing mode generally refers to a mode of an application, such as a camera application, to obtain an image, other than the video recording mode. For example, the photographing mode may include a photo mode, a portrait mode, a panorama mode, or a square (image) mode, etc. The video recording mode mentioned above may include a normal video mode, a slow motion mode, or a time-lapse mode, etc. For instance, in response to detecting the preset operation instruction to the camera button from the user, the mobile terminal may switch from the photo mode to the video recording mode, or from the portrait mode to the slow motion mode, etc.

The preset operation instruction may be provided through various means, including but not limited to, at least one of a long-pressing or a firm-pressing, etc., the camera button, which may vary depending actual needs. For example, in some embodiments, the preset operation instruction may be provided through long-pressing the camera button. In some embodiments, based on a determination that a pressing duration of the camera button is greater than or equal to a first duration, the preset operation instruction is determined to be received and the mobile terminal responds to the preset operation instruction accordingly.

The first duration may be set based on an empirical value, such as 0.5 seconds, 0.7 seconds, 1.6 seconds, etc., which is not limited herein. It is understood that setting a duration too short may cause the user to switch modes by mistake and setting a duration too long may cause the user to miss the moment they want to capture. Therefore, the first duration may be chosen through balancing a chance of false switch with the response speed of the switch.

In some embodiments, based on a determination that the pressing duration of the camera button is less than the first duration, the mobile terminal may be enabled or controlled to take a photo. It is understood that the method distinguishes between taking a photo and recording a video through setting different pressing durations. That is, long-pressing the camera button means to start recording a video and short-pressing the camera button means to take a regular photo.

In some embodiments, the preset operation instruction may be provided through applying sufficient pressure on the camera button. For example, based on a determination that a magnitude of pressure on the camera button is greater than or equal to a first pressure value, the preset operation instruction is determined to be received and the mobile terminal responds to the preset operation instruction accordingly. Similarly, the first pressure value may be set based on an empirical value and etc., which is not limited herein.

In some embodiments, based on a determination that the magnitude of pressure on the camera button is less than the first pressure value, the mobile terminal may be enabled or controlled to take a photo. It is understood that the method distinguishes between taking a photo and recording a video through setting different pressure values. That is, firm-pressing the camera button (i.e., the magnitude of pressure on the camera button is sufficient enough) means to start recording a video and light-pressing the camera button means to take a regular photo.

In some embodiments, the preset operation instruction may be provided through applying a sufficient pressure on the camera button for a required pressing duration. For instance, based on a determination that the magnitude of pressure on the camera button is greater than or equal to a second pressure value and the pressing duration is greater than or equal to a second duration, the preset operation instruction is determined to be received.

In some embodiments, the mobile terminal is enabled or controlled to take a photo, based on any one of the following conditions: the magnitude of pressure on the camera button is less than the second pressure value and the pressing duration of the camera button is greater than or equal to the second duration, the magnitude of pressure on the camera button is greater than or equal to the second pressure value and the pressing duration of the camera button is less than the second duration, or the magnitude of pressure on the camera button is less than the second pressure value and the pressing duration of the camera button is less than the second duration. Based on a combination of the pressing duration and the magnitude of pressure on the camera button, an accuracy in determining whether the preset operation instruction is received may be improved. Apparently, additional pressing durations and additional pressure values may be set to define more functions to be triggered, which should fall within the scope of the present disclosure as well.

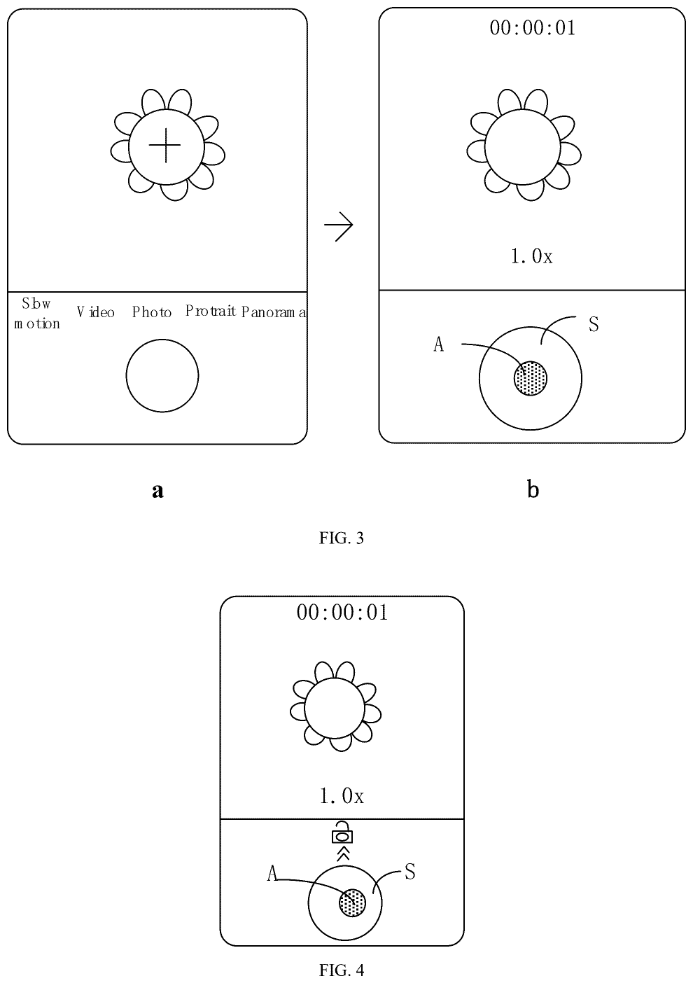

In the operation S110 above, the mobile terminal, in response to detecting the preset operation instruction to the camera button, enters the video recording mode and starts recording a video. In this case, the mobile terminal simultaneously enters a video recording interface. In some embodiments, in a case where the mobile terminal is in the photo mode, in response to detecting a corresponding or related operation on the camera button in a photo mode interface (e.g., an interface A in FIG. 3), the photo mode interface is controlled or enabled to quickly transition to the video recording interface (e.g., an interface B in FIG. 3) and the mobile terminal starts recording a video. In some embodiments, the video recording interface may be configured to display a recorded image and a recording duration in real time.

In some embodiments, after the mobile terminal enters the video recording interface, besides displaying the recording duration and etc. above, the mobile terminal is further configured to display a movable floating icon (referred to as a movable icon) in the video recording interface. The movable icon is configured to enable the user to adjust one or more video recording parameters through moving the movable icon. For example, the user may move the movable icon to adjust a focal length for a long shot or a close-up shot, and adjust a brightness, a contrast, and etc.

In an operation S120, the video recording interface may be controlled or enabled to display a movable icon and a move operation instruction to the movable icon may be received.

The movable icon may move as the user slides the movable icon. For instance, as shown in the interface B of FIG. 3, the movable icon A is in shape of a floating sphere. The movable icon A may be displayed in other manners, which is not limited herein. In some embodiments, the movable icon A may be derived from the camera button originally in a photographing interface by modification or conversion. In this case, after the user enters the video recording interface through pressing the camera button, the user is able to continue sliding the movable icon A to adjust to a composition, a filter, or an exposure parameter, etc., of the recording, without having to first lift their hand from the screen. In some embodiments, the movable icon A may be pre-configured in the video recording interface. In this case, an initial position of the movable icon A is determined based on a position on which the user presses, and the camera button originally in the photographing interface may be deactivated and become invisible, etc.

Considering that a single-handed operation may often be limited to a certain range, to avoid an excessive movement of the movable icon that may lead to difficulty in returning and to facilitate triggering recording setting instructions, etc., some embodiments of the present disclosure further define a control region S for the movable icon A to limit a moving range of the movable icon A. For example, in the interface B of FIG. 3, a circular area S encloses the movable icon A. The movable icon A may not leave or will not entirely get or move out of the control region S during the movement. In other words, the movable icon A only moves in an area that intersects with the control region S, ensuring that the movable icon A will not move out of the control region S, i.e., the movable icon A remains at least partially located within the control region S.

The operations S110 and S120 for controlling the display of the video recording interface may be performed in any order, which is not limited herein. In the operation S120, when the mobile terminal enters the video recording interface, the mobile terminal may detect whether the user continues to move the movable icon. In a case where the mobile terminal receives the move operation instruction to the movable icon, the method proceeds to operation S130.

In an operation S130, one or more video recording parameters may be adjusted based on the move operation instruction to the movable icon.

In some embodiments, the video recording interface further includes one or more function setting regions. Each function setting region corresponds to a different recording setting instruction and is configured to adjust or set a corresponding one of the one or more video recording parameters. The video recording parameters are different from each other. For example, the video recording parameters may include, but are not limited to, any one or more of the following parameters: a video recording state, an optical zoom, a filter, a brightness, an exposure, and etc.

In some embodiments, as shown in FIG. 4, the video recording interface may include a recording locked icon. The recording locked icon is configured to visually prompt the user to slide the movable icon A to an area identified by the recording locked icon, so as to lock a current video recording state. In this case, the method for recording a video may further include the following operations. The movable icon A is controlled or enabled to stop moving and the current video recording state is maintained, based on a detection that the movable icon A slides to the recording locked icon. It can be understood that the locking the current video recording state means that, in a case where the user slides the movable icon A to a position of the recording locked icon and then releases the movable icon A, the mobile terminal remains in the current video recording state, rather than stopping recording the video after the user releases the movable icon A.

In some embodiments, when the video recording state is locked, the user may unlock the video recording state through clicking or pressing the movable icon A again. Consequently, the mobile terminal stops recording the video and the recorded video is stored in the mobile terminal. The recording duration is not limited herein, and the user may stop recording anytime based on actual needs. In some embodiments, after the video recording state is locked, the user may unlock the video recording state through sliding the recording locked icon to an area at which the movable icon A stops or long-pressing the recording locked icon, and etc. In this case, after the video recording state is unlocked, the mobile terminal may continue recording the video and the movable icon A becomes movable again, allowing the user to further adjust a current recording object and etc. through sliding the movable icon A.

It should be understood that pressing the movable icon A again to stop recording the video after the video recording state is unlocked, adjusting the one or more video recording parameters again after the video recording state is unlocked, and other functions, may be set based on actual needs. Any operation derived from the above operation of locking the video recording state falls within the scope of the present disclosure.

In addition, the one or more function setting regions mentioned above may be configured to adjust another video recording parameter. The locking the current recording state may be a function setting that corresponds to one of the one or more function setting regions.

In some embodiments, the one or more function setting regions may be set in the following manner. The video recording interface includes a residence region and one or more function setting regions around the residence region. Each of the one or more function setting regions is configured to adjust a corresponding one of the one or more video recording parameters. The one or more video recording parameters are different from each other. The number of the one or more function setting regions may be one, two, or more than two. It can be understood that an area of the residence region is slightly larger than an area of the movable icon, thereby reserving a certain safety space for the movable icon. That is, when the movable icon moves within the residence region, no recording setting instruction may be triggered. Once the movable icon exceeds the residence region, a corresponding recording setting instruction may be triggered.

In the above embodiments, when the mobile terminal is recording a video, the method for recording a video may further include: based on a detection that the movable icon moves outside the residence region S0, one function setting region at which the movable icon is located is identified and a corresponding video recording parameter that corresponds to the identified function setting region may be adjusted. For example, when the user moves the movable icon outside the residence region, a moving trajectory of the movable icon may be obtained. Then, the function setting region that is reached by the movable icon may be identified. After the function setting region that is reached by the movable icon is determined, the video recording parameter that corresponds to the identified function setting region may be adjusted.

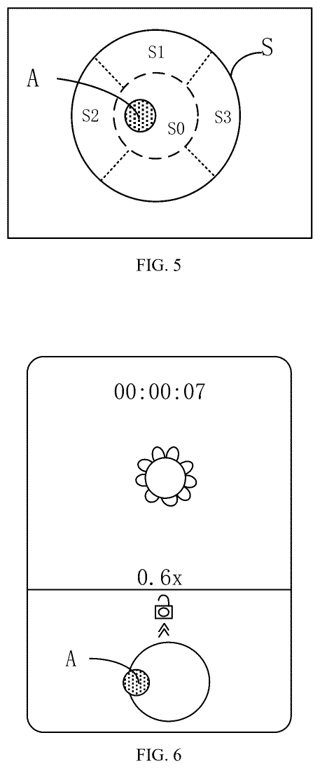

In some embodiments, when the above-mentioned control region S is set, the control region S may include both the residence region S0 and the one or more function setting regions mentioned above. In some embodiments, as shown in FIG. 5, a division of the control region S may be set to be invisible in an actual terminal interface. The residence region S0 is located at a center of the control region S. The one or more function setting regions are arranged around the residence region S0. In some embodiments, the one or more function setting regions may be three fan-shaped regions shown in FIG. 5. In some embodiments, the number of the one or more function setting regions may be four, five, six, and etc.

As shown in FIG. 5, taking three function setting regions being arranged in the control region S as an example, the control region S includes a first function setting region S1, a second function setting region S2, and a third function setting region S3. The first function setting region S1 corresponds to a recording state lock instruction and is configured to set the video recording state. The second function setting region S2 corresponds to a zoom-out instruction and is configured to reduce an optical zoom. The third function setting region S3 corresponds to a zoom-in instruction and is configured to increase the optical zoom. In this case, the second function setting region S2 and the third function setting region S3 are arranged in opposite.

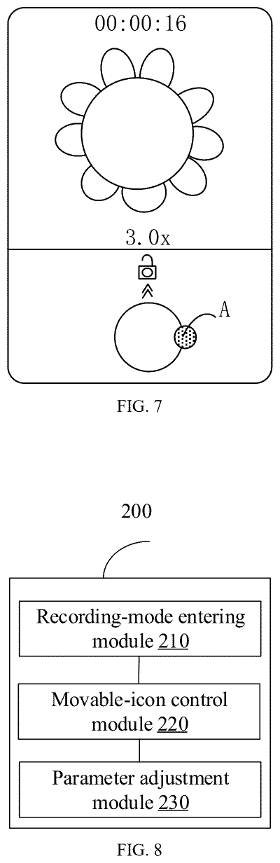

Therefore, based on an identification that the movable icon A moves to the first function setting region S1, the video recording state is set to a locked recording state. In this case, a recording state flag is set to a value that corresponds to the current video recording state, etc. In some embodiments, based on an identification that the movable icon A moves to the second function setting region S2, the optical zoom is reduced. For example, as shown in FIG. 6, when the movable icon A slides leftward, the optical zoom decreases from 1.0× to 0.6×. As the movable icon A continues sliding leftward, the optical zoom keeps decreasing until a minimum value of the optical zoom is reached. In some embodiments, based on an identification that the movable icon A moves to the third function setting region S3, the optical zoom is increased. For example, as shown in FIG. 7, when the movable icon A slides rightward, the optical zoom increases from 0.6× to 3.0×. As the movable icon A continues sliding rightward, the optical zoom keeps increasing until a maximum value of the optical zoom is reached. Besides, the user may slide the movable icon A to a recording locked region after finishing adjusting other video recording parameters, thereby ensuring the video to continue being recorded in the current video recording state after the user releases the movable icon.

It can be understood that, sliding the movable icon upward to lock the video recording state and sliding the movable icon horizontally to adjust the focal length as mentioned above are merely some examples. A division of the function setting regions and an allocation of the function setting may be adjusted as needed in practice, which are not limited herein. For instance, the second function setting region and the third function setting region may be configured to adjust the brightness and the exposure, respectively. The number of the function setting regions may correspond to the number of the recording setting instructions. In a case where an additional recording setting instruction is required, an additional functional setting region may be included, which may be configured based on actual needs.

In general, when mobile terminals launch an application, such as a system camera, a photo mode interface (e.g., the interface a shown in FIG. 3) may be entered by default. The photo mode interface includes a camera button. Once the user presses or clicks the camera button for one time, one photo is taken. To switch from the photographing mode to the video recording mode, the user has to swipe or slide leftward or rightward on a screen display area in order to use a video recording function. Then, the user needs to press the camera button to start recording a video. Apparently, multiple operations required may result in a longer operation time, making it difficult to meet user needs for recording dynamic scenes instantly and etc.

Therefore, in some embodiments of the present disclosure, corresponding operations are performed on the camera button in the photographing mode, and the floating movable icon is displayed on the video recording interface, on one hand, it is possible to swiftly initiate the video recording, and on the other hand, it facilitates the user to perform a single-handed, one-click operation to adjust the plurality of video recording parameters. For instance, after the user presses the camera button to enter the video recording interface, the user may continue to slide the movable icon without interrupting the operation, to adjust the video recording parameter, thereby realizing the one-click operation from entering the video recording interface to adjusting the video recording parameter.

The method for recording a video provided by some embodiments of the present disclosure enables the mobile terminal to swiftly enter the video recording mode to start recording a video by performing corresponding operations on the camera button, and thus the user does not need to perform multiple operations. Furthermore, the user is allowed to use one hand to slide the floating movable icon to different function setting regions in the video recording interface. In this way, on one hand, the method significantly simplifies the process of setting the video recording parameter during recording, such that the user is no longer required to click or adjust different areas of the video recording interface back and forth, realizing a simple and convenient operation and greatly improving the efficiency in recording the video. On the other hand, the movable icon may move along as the user slides the movable icon, providing an intuitive and interactive experience. Besides, the video recording state may be locked so that the user no longer has to keep pressing the camera button to maintain an uninterrupted recording. In some embodiments, the user may lock the video recording state after adjusting the plurality of video recording parameters, such as the focal length, the filter, and the brightness, and etc.

### Embodiment 2

As shown in FIG. 8, based on the method in the Embodiment 1, the Embodiment 2 provides an apparatus for recording a video. The apparatus may be applied to or configured in a mobile terminal. In some embodiments, an apparatus 200 for recording a video may include the following modules.

A recording-mode entering module 210 may be configured to control the mobile terminal to enter a video recording mode and start recording a video, in response to a preset operation instruction to a camera button, in a case where the mobile terminal is in a photographing mode.

A movable-icon control module 220 may be configured to control a video recording interface to display a movable icon and receive a move operation instruction to the movable icon.

A parameter adjustment module 230 may be configured to adjust one or more video recording parameters based on the move operation instruction to the movable icon.

It can be understood that the embodiments provided in the Embodiment 1 may be further applied to the method in the Embodiment 2, which will not be repeated herein.

Some embodiments of the present disclosure further provide a mobile terminal, such as a mobile phone or tablet, etc. In some embodiments, the mobile terminal includes a camera device, a processor, and a memory. The camera device is configured to take a photo or record a video. The memory stores a computer program which, when executed by the processor, causes the mobile terminal to perform the method for recording a video described above or execute the function of each module in the apparatus for recording a video described above.

Some embodiments of the present disclosure further provide a readable storage medium. The readable storage medium stores the computer program used in the mobile terminal described above.

In some embodiments of the present disclosure, it should be understood that the disclosed apparatus and method may further be implemented in other ways. The described apparatus embodiment is merely illustrative. For example, the flowcharts and the structural block diagrams in the figures only show some possible architectures, functions, and operations for the apparatus, the method, and the computer program products based on some embodiments of the present disclosure. In this regard, each block in the flowcharts or the structural block diagrams may represent a module, a program segment, or a part of code that contains one or more executable instructions for implementing a specified logical function. It should be further noted that, in alternative embodiments, the functions labeled in the blocks may perform in a different order than shown in the figures. For instance, two consecutive blocks may actually be executed in parallel, and they may sometimes be executed in the reverse order, depending on the functions involved. It should be further noted that each block in at least one of the structural block diagrams or at least one of the flowcharts, as well as combinations of blocks in at least one of the structural block diagrams or at least one of the flowcharts, may be implemented using a dedicated hardware-based system that performs the specified functions or actions, or a combination of dedicated hardware and computer instructions.

Besides, the functional modules or units in the various embodiments of the present disclosure may be integrated to form an independent part, or the modules may exist separately, or two or more modules may be integrated to form an independent part.

When the functions are implemented as software functional modules and sold or used as independent products, they can be stored in a computer-readable storage medium. Based on this understanding, the technical solutions of the present disclosure in essence, or parts of the present disclosure that contribute to the related art, may be embodied in the form of a software product. The computer software product is stored in a storage medium and includes several instructions to cause a computing device (such as, a mobile phone, a personal computer, a server, or a network device) to execute all or part of the operations of the methods described in the embodiments of the present disclosure. The aforementioned storage mediums may include: a universal serial bus (USB) drive, an external hard drive, a read-only memory (ROM), a random access memory (RAM), a magnetic disk, an optical disk, and other media capable of storing program codes.

The above are specific embodiments of the present disclosure, but the scope of the present disclosure is not limited herein. Those skilled in the art may easily conceive of variations or replacements within the disclosed technical scope, which should be covered by the scope of the present disclosure.

1. A method for recording a video, comprising:
controlling a mobile terminal to enter a video recording mode and start recording a video, in response to an operation instruction to a camera button, in a case where the mobile terminal is in a photographing mode;
controlling a video recording interface to display a movable icon and receiving a move operation instruction to the movable icon; and
adjusting one or more video recording parameters based on the move operation instruction to the movable icon.

2. The method as claimed in claim 1, wherein the video recording interface comprises a recording locked icon, and the method further comprises:
controlling the movable icon to stop moving and maintaining a current video recording state, based on a detection that the movable icon slides to a position of the recording locked icon.

3. The method as claimed in claim 1, wherein the video recording interface comprises a residence region and one or more function setting regions around the residence region, each of the one or more function setting regions is configured to adjust a corresponding different one of the one or more video recording parameters;
the adjusting one or more video recording parameters based on the move operation instruction to the movable icon, comprises:
identifying one of the one or more function setting regions at which the movable icon is located, based on a detection that the movable icon moves outside the residence region; and
adjusting a corresponding one of the one or more video recording parameters that corresponds to the identified function setting region.

4. The method as claimed in claim 3, wherein the video recording interface further comprises a control region, the control region comprises the residence region and at least two function setting regions, the residence region is located at a center of the control region, and the movable icon is configured to move in a way that the movable icon remains at least partially located in the control region.

5. The method as claimed in claim 3, wherein the video recording interface comprises three function setting regions, the three function setting regions comprise a first function setting region, a second function setting region, and a third function setting region, and the second function setting region and the third function setting region are arranged in opposite;
the adjusting a corresponding one of the one or more video recording parameters that corresponds to the identified function setting region, comprises:
switching a video recording state to a locked recording state, based on an identification that the movable icon moves to the first function setting region;
reducing an optical zoom, based on an identification that the movable icon moves to the second function setting region; and
increasing the optical zoom, based on an identification that the movable icon moves to the third function setting region.

6. The method as claimed in claim 1, wherein a detection of the operation instruction to a camera button, comprises:
determining that the operation instruction is received, based on a determination that a pressing duration of the camera button is greater than or equal to a first duration.

7. The method as claimed in claim 1, wherein a detection of the operation instruction to a camera button, comprises:
determining that the operation instruction is received, based on a determination that a magnitude of pressure on the camera button is greater than or equal to a first pressure value.

8. The method as claimed in claim 1, wherein a detection of the operation instruction to a camera button, comprises:
determining that the operation instruction is received, based on a determination that a magnitude of pressure on the camera button is greater than or equal to a second pressure value and a pressing duration of the camera button is greater than or equal to a second duration.

9. The method as claimed in claim 6, further comprising:
controlling the mobile terminal to take a photo, based on a determination that the pressing duration of the camera button is less than the first duration.

10. The method as claimed in claim 7, further comprising:
controlling the mobile terminal to take a photo, based on a determination that the magnitude of pressure on the camera button is less than the first pressure value.

11. The method as claimed in claim 8, further comprising:
controlling the mobile terminal to take a photo, based on any one of the following conditions:
the magnitude of pressure on the camera button is less than the second pressure value and the pressing duration of the camera button is greater than or equal to the second duration;
the magnitude of pressure on the camera button is greater than or equal to the second pressure value and the pressing duration of the camera button is less than the second duration; or
the magnitude of pressure on the camera button is less than the second pressure value and the pressing duration of the camera button is less than the second duration.

12. (canceled)

13. A mobile terminal, comprising a camera device, a memory, and a processor, wherein the camera device is configured to take a photo or record a video, the memory stores a computer program which, when executed by the processor, causes the processor to perform a method for recording a video, and the method comprises:
controlling a mobile terminal to enter a video recording mode and start recording a video, in response to an operation instruction to a camera button, in a case where the mobile terminal is in a photographing mode;
controlling a video recording interface to display a movable icon and receiving a move operation instruction to the movable icon; and
adjusting one or more video recording parameters based on the move operation instruction to the movable icon.

14. A non-transitory computer-readable storage medium storing a computer program which, when executed by a processor, causes the processor to perform a method for recording a video, and the method comprises:
controlling a mobile terminal to enter a video recording mode and start recording a video, in response to an operation instruction to a camera button, in a case where the mobile terminal is in a photographing mode;
controlling a video recording interface to display a movable icon and receiving a move operation instruction to the movable icon; and
adjusting one or more video recording parameters based on the move operation instruction to the movable icon.

15. The method as claimed in claim 3, wherein an adjusted amount of the corresponding one of the one or more video recording parameters is positively correlated to a moving distance of the movable icon in the identified function setting region.

16. The mobile terminal as claimed in claim 13, wherein the video recording interface comprises a recording locked icon, and the method further comprises:
controlling the movable icon to stop moving and maintaining a current video recording state, based on a detection that the movable icon slides to a position of the recording locked icon.

17. The mobile terminal as claimed in claim 13, wherein the video recording interface comprises a residence region and one or more function setting regions around the residence region, each of the one or more function setting regions is configured to adjust a corresponding different one of the one or more video recording parameters;
the adjusting one or more video recording parameters based on the move operation instruction to the movable icon, comprises:
identifying one of the one or more function setting regions at which the movable icon is located, based on a detection that the movable icon moves outside the residence region; and
adjusting a corresponding one of the one or more video recording parameters that corresponds to the identified function setting region.

18. The mobile terminal as claimed in claim 17, wherein the video recording interface comprises three function setting regions, the three function setting regions comprise a first function setting region, a second function setting region, and a third function setting region, and the second function setting region and the third function setting region are arranged in opposite;
the adjusting a corresponding one of the one or more video recording parameters that corresponds to the identified function setting region, comprises:
switching a video recording state to a locked recording state, based on an identification that the movable icon moves to the first function setting region;
reducing an optical zoom, based on an identification that the movable icon moves to the second function setting region; and
increasing the optical zoom, based on an identification that the movable icon moves to the third function setting region.

19. The non-transitory computer-readable storage medium as claimed in claim 14, wherein the video recording interface comprises a recording locked icon, and the method further comprises:
controlling the movable icon to stop moving and maintaining a current video recording state, based on a detection that the movable icon slides to a position of the recording locked icon.

20. The non-transitory computer-readable storage medium as claimed in claim 14, wherein the video recording interface comprises a residence region and one or more function setting regions around the residence region, each of the one or more function setting regions is configured to adjust a corresponding different one of the one or more video recording parameters;
the adjusting one or more video recording parameters based on the move operation instruction to the movable icon, comprises:
identifying one of the one or more function setting regions at which the movable icon is located, based on a detection that the movable icon moves outside the residence region; and
adjusting a corresponding one of the one or more video recording parameters that corresponds to the identified function setting region.

21. The non-transitory computer-readable storage medium as claimed in claim 20, wherein the video recording interface comprises three function setting regions, the three function setting regions comprise a first function setting region, a second function setting region, and a third function setting region, and the second function setting region and the third function setting region are arranged in opposite;
the adjusting a corresponding one of the one or more video recording parameters that corresponds to the identified function setting region, comprises:
switching a video recording state to a locked recording state, based on an identification that the movable icon moves to the first function setting region;
reducing an optical zoom, based on an identification that the movable icon moves to the second function setting region; and
increasing the optical zoom, based on an identification that the movable icon moves to the third function setting region.
